(19) United States
(12) Patent Application Publication
(10) Pub. No.: US 2006/0174605 A1
(43) Pub. Date: Aug. 10, 2006

(54) Berry zero hydrocarbons engine

(76) Inventors: Benny Lee Berry, Palmdale, CA (US); Benjamin Lawrence Berry, Lake Oswego, OR (US); Perry Greenwood Rucker, Los Angeles, CA (US)

Correspondence Address: BENNY LEE BERRY, 40535 Milan Drive, Palmdale, CA, 93551, US

(21) Appl. No.: 11/059,071

(22) Filed: Feb. 7, 2005

(51) Int. Cl. F02C 3/20

(52) U.S. Cl. 60/39.462

(57) ABSTRACT

The Berry Zero Hydrocarbons Engine is a new and useful type of engine which does not require the internal combustion of hydrocarbon fuels. This engine will offer the opportunity for reduced environmental impacts. This invention ushers in a new type of transportation motive power unit class of invention.

### BACKGROUND OF THE INVENTION

This invention relates, generally, to an engine that is capable of operations as an engine for Transportation Vehicles. The increasing number of hydrocarbon-based engines has resulted in increased air pollution caused by the emissions of hydrocarbon particles and gases. However, air pollution in economically developed countries has diminished over recent decades as a result of changing fuel use patterns, such as the increased use of cleaner burning fuels like natural gas.

Traffic pollution problems are worsening World-wide. In both developed and developing countries, the threat to clean air is now posed by traffic emissions. Diesel-engined motor vehicles emit a wide variety of pollutants, principally, Carbon Monoxide (CO), Carbon Dioxide (CO₂), Oxides of Nitrogen (NOₓ), Volatile Organic Compounds (VOC) and particulates, all of which have increasing impacts on Urban Air Quality. Carbon Dioxide emissions are increasing at 4% per year and contributes to Global Warming.

Motor vehicles produce high levels of Carbon Monoxide and are a major source of hydrocarbons and Oxides of Nitrogen. The time has arrived for a paradigm shift in the design of internal combustion engines. The time has come for an engine which does not require hydrocarbon-based fuels.

### BRIEF SUMMARY OF THE INVENTION

It is an object of this invention to provide a new and useful engine which does not burn hydrocarbon fuels.

It is another object of the invention to reduced emissions which negatively impacts the quality of the air.

Yet another object is to reduce dependency upon foreign sources of crude oil.

As we enter the 21^{st} Century, some inventors are looking to use their creativity to find ways to reduce this Country's dependency upon foreign petroleum resources and reduction of pressures to increase domestic crude oil production.

According to one aspect of this invention, it provides an engine which permits the operations of an engine without reliance upon various kinds of petroleum-based fuel products. This is achieved by using fuels which are comprised of elements commonly found in the air that we breathe, such as Oxygen, Hydrogen, and Nitrogen.

### BRIEF DESCRIPTION OF THE DRAWING

FIG. 1 Berry Zero Hydrocarbons Engine Schematic

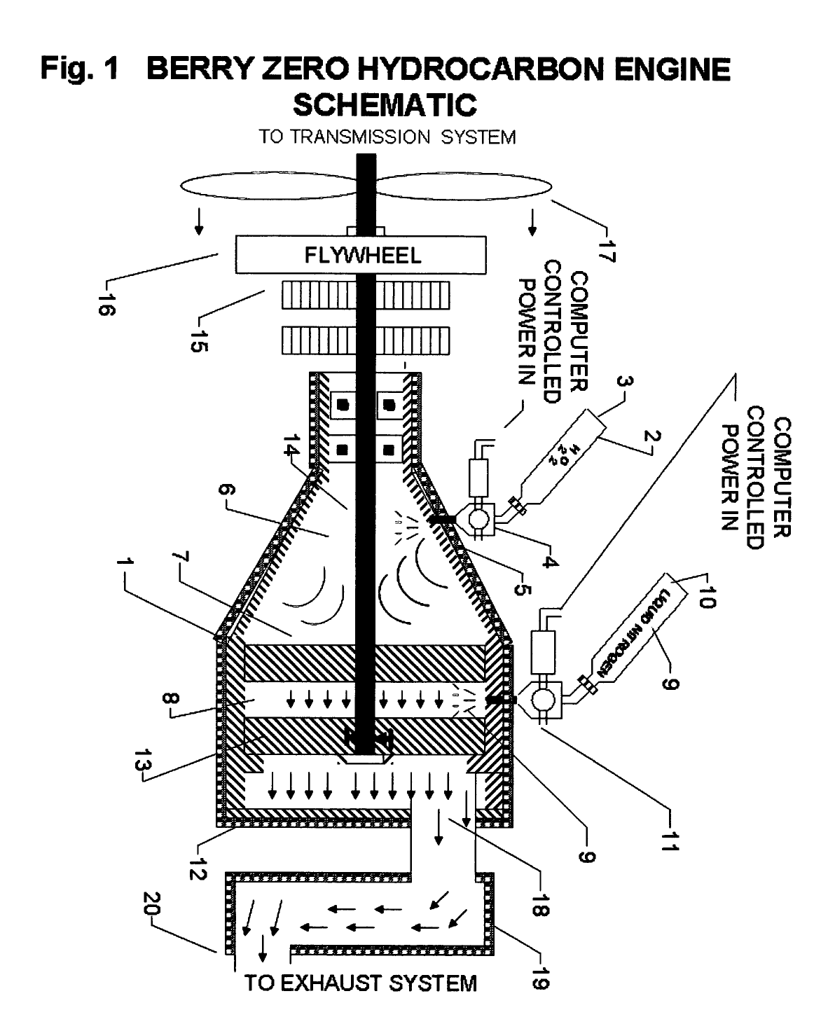

In FIG. 1 there is depicted an engine and its supporting Fuel Canisters. It shows a means of igniting the fuels without the use of spark plugs. It depicts a low weight-to-horsepower engine.

### DETAILED DESCRIPTION OF THE INVENTION

Referring initially to FIG. 1 of the Drawing, the engine 1 is a closed-cycle operations engine which has no Air Intake Manifold. It requires no Fuel-to-Air Ratio. The engine is made of high strength-to-weight Titanium honey-comb metal. The overall weight of the engine is under 100 pounds. The entire interior of the engine is coated with Teflon material. The exterior is coated with insulated composite materials. The exterior is air-cooled during operations.

The engine does not require a carburetor. The 100% Hydrogen Peroxide Fuel 2 is metered from the Hydrogen Peroxide Canister 3 through the Hydrogen Peroxide Fuel Pump 4 directly through a catalytic screen 5 into the Forward Primary Chamber 6. The catalyst results in spontaneous flaming heat and gases, O₂ and H₂ which flow through a freely revolving Gas Impeller 7 This rotating Gas Impeller directs the flow of hot gases into the Secondary Chamber 8 where the Liquid Nitrogen 9 introduced from the Liquid Nitrogen Canister 10 by the Liquid Nitrogen Fuel Pump 11 into this Chamber mixes with the hot gases and heat flowing in from the Primary Chamber. The Liquid Nitrogen is thereby converted to High Pressure Nitrogen Gas. This High Pressure Nitrogen Gas 12 causes the Torque Converter Gas Turbine 13 to spin at a very high angular rate of speed. This Torque Converter is physically attached to Central Drive Shaft 14 which rotates at the same high angular rate. The Central Drive Shaft drives the Gear Reduction Gears 15 which drives high speed Hydraulic Pumps. The Central Drive Shaft is also attached to the Flywheel 16 and the Engine Cooling Fan 17. The high pressure exhaust gases pass through the Exhaust Manifold 18 and out through the Potassium Chloride Cartridge Filter 19, where the exhaust is filtered to remove NOx contaminants, then passes out the Tailpipe 20. The Central Drive Shaft is also connected through the gears in the transmission to the Gear Train which drives the wheels of the vehicle.

While this invention is herein described by way of some selected embodiments, it should be understood that the invention is not limited to these particular embodiments and other combinations are possible without departing from the scope and principles of this invention, as defined in the appended claims.

We claim:

1. An engine and Potassium Chloride Cartridge combination which removes NOx emissions from the Exhaust System.

2. An internal combustion engine that produces no hydrocarbon emissions.

3. An engine that combines the combustion of 100% Hydrogen Peroxide and liquid Nitrogen to produce motive power.

4. An engine that utilizes the pressure of hot gases produced by catalytic action on 100% Hydrogen Peroxide and liquid Nitrogen to produce torque on a turbine-shaft combination.

5. A quietly operating engine that produces high pressure exhaust gases through a gas turbine and through a muffler to provide useful work for motive power.

6. An engine that utilizes a Titanium Honeycomb metal structure to produce a low weight-to horsepower engine.

7. An engine that is supported by Fuel Canisters instead of Fuel Tanks to supply two separate fuels to the engine that are combined in the engine for internal combustion.
